(19) United States
(12) Patent Application Publication
(10) Pub. No.: US 2024/0185299 A1
(43) Pub. Date: Jun. 6, 2024

(54) Digital display method and system for outdoor advertising

(71) Applicant: JCDECAUX SE, . (FR)

(72) Inventor: Loïc BIDARD, Paris (FR)

(73) Assignee: JCDECAUX SE, . (FR)

(21) Appl. No.: 18/554,361

(22) PCT Filed: Apr. 8, 2022
(86) PCT No.: PCT/EP2022/059465

§ 371 Date: Oct. 6, 2023

(30) Foreign Application Priority Data
Apr. 8, 2021 (FR) FR2103617

(51) Int. Cl. G06Q 30/0251; G06Q 30/0273

(52) U.S. Cl. CPC G06Q 30/0264; G06Q 30/0275

(57) ABSTRACT

A display method comprising: generating by a platform for generating playlists, playlists intended for digital display devices, the playlists having free time slots; synchronizing digital display devices with the playlist generation platform; for each free time slot of each playlist, corresponding to a digital display device, sending a content request by the platform for generating playlists, to a programmatic platform for selling advertising space, the programmatic platform being adapted to emit a corresponding bid and to send back to the platform for generating playlists, information corresponding to content having won the bid; informing of the content having won the bid, by said platform for generating playlists, the at least one digital display device corresponding to the free time slot.

### TECHNICAL FIELD

The present description relates to digital display methods and systems for outdoor advertising (“OOH” advertising), i.e. for advertising visible to all in places accessible to the public.

### TECHNICAL BACKGROUND

Digital display methods are known to allow deploying playlists and contents to digital display devices.

### SUMMARY

One of the aims of the present description is to improve the efficiency of these methods, in particular to allow deploying playlists and contents in near real time, including to a large number of digital display devices.

To this end, the present description proposes a digital display method for outdoor advertising for controlling the display of digital contents by digital display devices, comprising:
generating by a platform for generating playlists, playlists according to displaying campaigns, each playlist comprising information necessary for one or several of said digital display devices to display a set of digital contents during successive time slots, at least some of the playlists having free time slots which are not assigned to a determined digital content;
repeatedly synchronizing the digital display devices with said platform for generating playlists so that each digital display device has in memory the updated playlist generated for it by said platform for generating playlists;
for each free time slot of each playlist, corresponding to at least one digital display device, sending a request for content by said platform for generating playlists, to a programmatic platform for selling advertising space, said programmatic platform for selling advertising space being adapted to emit an auctioning corresponding to said request for content and to send back to said platform for generating playlists, bid result information corresponding to a digital content having won the bid if the bid has been won;
if the bid has been won, informing of the content having won the bid, by said platform for generating playlists, said at least one digital display device corresponding to said free time slot.

Thanks to these provisions, the proposed digital display method is especially effective and economical in terms of processor capacity at the level of the digital display devices. In fact, the tasks to be performed by the digital display devices in the event of a won bid are very limited and very fast, which contributes to near-real-time operation. In addition, the interaction with the programmatic platform for selling advertising space is also simpler and faster, since it can be done from server to server.

In various embodiments of the digital display method, one and/or the other of the following arrangements can possibly further be used (alone or in all their mutual combinations, possibly independently of the aforementioned arrangements):
said programmatic platform for selling advertising space has the references of digital contents likely to win the bid in memory and the method further comprises;
having the digital display devices load in advance said digital contents likely to win the bid,
and in order to inform of which content has won the bid, said playlist generation platform indicates to said at least one digital display device corresponding to said free time slot, which digital content has won the bid among said digital contents likely to win the bid: these arrangements also contribute to near-real-time operation at the level of the digital display devices, even when the connectivity of the digital display devices is not very good (for example if the digital display devices communicate with a cellular network such as a 3G or 4G network);
the method further comprises:
transmitting by said playlist generation platform, to the digital display devices, loading addresses corresponding to the digital contents to be respectively loaded by said digital display devices;
loading said digital contents by the digital display devices from said loading addresses;
each playlist includes at least one set of identifiers for digital contents to be played but does not include addresses for loading the digital contents and the method further comprises:
generating by said platform for generating playlists, for each digital display device, a loading manifest comprising at least addresses for loading digital contents;
the synchronization of the digital display devices with said playlist generation platform comprising;
interrogating said playlist generation platform, at predetermined intervals, by each digital display device, in order to determine if said playlist generation platform has a new playlist and/or new loading manifest corresponding to said digital display device;
if so, loading said new playlist and/or said new loading manifest into the digital display device;
if a new loading manifest has been loaded from the server, determining by said digital display device which is/are the new digital content(s) referenced in said loading manifest;
and downloading by said digital display device, said new digital content(s) from the address(es) indicated in the new loading manifest;
when a playlist includes a free time slot, said playlist includes, for said free time slot, the identifiers of said digital contents likely to win the bid, and the loading manifest corresponding to said playlist includes the addresses for loading said digital contents likely to win the bid,
and in order to inform of the content having won the bid, said platform (7) for generating playlists sends an activation order of said digital content having won the bid for said free time slot;
the step of sending a request for content is repeatedly performed for each free time slot, while the bid has not been won;
the step of sending a request for content is performed at the latest between T and 2T before the free time slot, T being the duration of the time slot preceding said free time slot;
said playlist generation platform imposes free time slots when said playlist generation platform generates playlists according to displaying campaigns controlled independently from the programmatic platform for selling advertising space;
categories are assigned to the digital contents, said playlist generation platform assigns at least one prohibited category respectively to the free time slots according to the contents already assigned to the adjacent time slots, and during said step of sending a request for content, said platform for generating playlists indicates the prohibited categories to said programmatic platform for selling advertising space;

Each digital display device is made to load in advance only those of the said digital contents likely to win the bid which have a category other than the said at least one prohibited category for the free time slots corresponding to this digital display device.

Furthermore, the present description also has as an object a digital display system for outdoor advertising comprising digital display devices and a playlist generation platform, wherein:
said platform for generating playlists is adapted to generate playlists according to displaying campaigns, each playlist comprising information necessary for one or several of said digital display devices to display a set of digital contents during successive time slots, at least some of the playlists having free time slots which are not assigned to a determined digital content;
the digital display system being adapted to repeatedly synchronize the digital display devices with said platform for generating playlists so that each digital display device has in memory the updated playlist generated for it by said platform for generating playlists;
for each free time slot of each playlist, corresponding to at least one digital display device, said playlist generation platform is adapted to send a content request to a programmatic platform for selling advertising space adapted to emit an auctioning corresponding to said content request and to send back to said playlist generation platform, bid result information corresponding to a digital content having won the bid if the bis has been won;
said platform for generating playlists is adapted to, if the bid has been won, inform of the content having won the bid, said at least one digital display device corresponding to said free time slot.

In various embodiments of the digital display system, one and/or the other of the following arrangements can possibly further be used (alone or in all their mutual combinations, possibly independently of the aforementioned arrangements):
the system further comprises said programmatic platform for selling advertising space,
and said programmatic platform for selling advertising space is adapted to send said bid to at least one programmatic platform for buying advertising;
in the digital display system:
said programmatic platform for selling advertising space has the references of digital contents likely to win the bid in memory;
the digital display system is adapted to have the digital display devices load in advance said digital contents likely to win the bid,
and in order to inform of which content has won the bid, said playlist generation platform is adapted to indicate to said at least one digital display device corresponding to said free time slot, which digital content has won the bid among said digital contents likely to win the bid;
in the digital display system:
said playlist generation platform is adapted to transmit to the digital display devices, loading addresses corresponding to the digital contents to be respectively loaded by said digital display devices;
the digital display devices are adapted to load said digital contents from said loading addresses;
in the digital display system:
each playlist includes at least one set of identifiers for digital contents to be played but does not include addresses for loading the digital contents;
said platform for generating playlists is adapted to generate, for each digital display device, a loading manifest comprising at least addresses for loading digital contents;
in order to synchronize the digital display devices with said platform for generating playlists, each digital display device is adapted to interrogate said platform for generating playlists at predetermined intervals, to determine if said playlist generation platform has a new playlist and/or a new loading manifest corresponding to said digital display device and if so, to load said new playlist and/or said new loading manifest into the digital display device;
said digital display device is adapted to, if a new loading manifest has been loaded from the server, determine which are the new digital content(s) referenced in said loading manifest and download said new digital content(s) from the address(es) specified in the new loading manifest;
when a playlist includes a free time slot, said playlist includes, for said free time slot, the identifiers of said digital contents likely to win the bid, and the loading manifest corresponding to said playlist includes the addresses for loading said digital contents likely to win the bid,
and in order to inform of the content having won the bid, said platform (7) for generating playlists is adapted to send an activation order of said digital content having won the bid for said free time slot;
said playlist generation platform is adapted to repeatedly send said request for content for each free time slot, while the bid has not been won;
said playlist generation platform is adapted to send said request for content at the latest between T and 2T before the free time slot, T being the duration of the time slot preceding said free time slot;
said playlist generation platform is configured to impose free time slots when said playlist generation platform generates playlists according to displaying campaigns controlled independently from the programmatic platform for selling advertising space;
categories are assigned to the digital contents, said playlist generation platform is configured to assign at least one prohibited category respectively to the free time slots according to the contents already assigned to the adjacent time slots, said platform for generating playlists indicates the prohibited categories to said programmatic platform for selling advertising space and when sending a request for content;
each digital display device is adapted to load in advance only those of the said digital contents likely to win the bid which have a category other than the said at least one prohibited category for the free time slots corresponding to this digital display device.

### BRIEF DESCRIPTION OF THE DRAWINGS

Other features and advantages of the digital display method and the digital display system will appear from the following description of one of their implementation forms, given as a non-limiting example, with reference to the attached drawings.

In the drawings:

FIG. 1 is a schematic view showing a digital display system according to an implementation form.

FIG. 2 is a schematic view showing an example of a playlist.

### DETAILED DESCRIPTION

In the various figures, the same reference signs designate identical or similar elements.

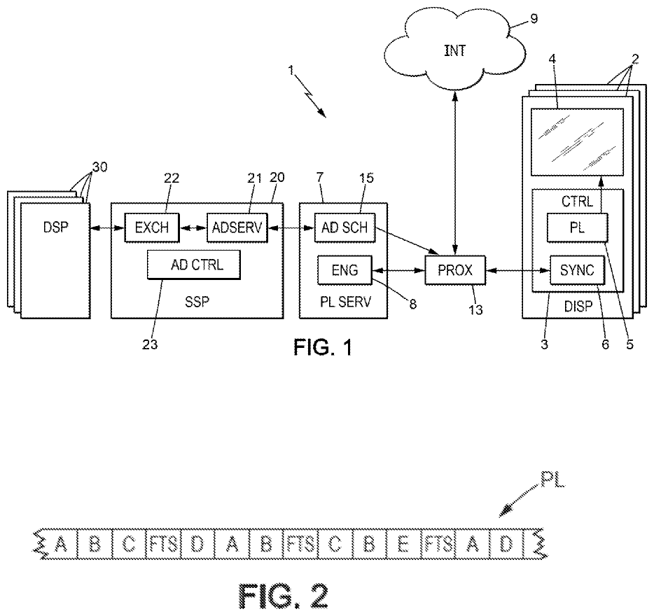

FIG. 1 shows a digital display system 1 comprising several digital display devices 2 (DISP). There may be a large number of digital display devices, possibly several thousands, possibly distributed over a wide geographical area.

Each display device 2 includes a control device 3 (CTRL) such as a microcomputer or the like, which controls a digital screen 4.

The control device 3 executes a digital content player 5 (PL) (software module executed by the control device 3) and also executes a synchronization software module 6 (SYNC).

The digital display system 1 further comprises a platform 7 for generating playlists (PL SERV), which is common to the aforementioned digital display devices 2. The platform 7 for generating playlists is a software package which can be executed on one server or several servers.

The platform 7 for generating playlists executes in particular an engine 8 (ENG) for generating lists of contents and loading manifests, as will be explained in more detail below.

The synchronization module 6 of each digital display device 2 communicates with the platform 7 for generating playlists and if necessary with other resources possibly present on the Internet 9 (INT). In the represented embodiment, the digital display devices 2 communicate with the platform 7 for generating playlists and with said other resources via at least one proxy server 13 (PROX).

This communication can be take place over any wide area network (WAN). For example, in many cases this communication can be made by a mobile telephone network (broadband cellular network, for example of the 3G or 4G type). Of course, any other communication means is possible.

Engine 8 is adapted to generate repeatedly and/or depending on certain triggering facts (modification of programming, of content, etc.) playlists according to the displaying campaigns in progress. This playlist generation is performed according to the reservations made by the advertisers concerning the various display devices 2, according to the digital contents to be read for these displaying campaigns and according to the available digital display devices.

Each playlist is intended to be played by one or several of said digital display devices 2.

Each playlist may comprise at least one set of identifiers for digital contents to be sequentially played, over one or several predetermined time periods, these digital contents being assigned to successive time slots. These time slots may or may not be of the same duration. The duration T of these time slots may in particular be for instance comprised between 5 and 20 s, by way of example 10 s.

According to an embodiment, the playlist does not include any address for loading the digital contents or any digital fingerprint of the digital contents; it is therefore a document representing a small volume of data.

The engine 8 is further adapted to generate repeatedly and/or depending on certain generating events (modification of programming, contents, etc.), for each digital display device, a loading manifest comprising at least addresses for loading the digital contents referenced in the loading list. Each loading manifest may further include, for each digital content, the identifier included in the playlist.

Each loading manifest can further comprise at least one reference digital fingerprint for each digital content being referenced in said loading manifest, according to an example, the digital fingerprint can be a checksum, for example of the “MD5” type. According to another example, the digital fingerprint can be a “GPG” type digital signature. According to a third example, the loading manifest can also comprise two reference digital fingerprints for each digital content, in particular a checksum for example of the “MD5” type and a more complex digital signature, for example of the “GPG” type.

The generation frequency of the playlists and loading manifests by the engine 8 can be variable according to the arrival speed of new reservations or reservation modifications by the advertisers. This frequency can go up to once every few minutes, or even higher frequencies, knowing that part of the reservations can be made by automatic online bids. As previously explained, certain playlist updates are carried out without changing the loading manifest when the modifications concern, for example, the digital contents playing order or frequency, or even the playing conditions of the digital contents.

The synchronization modules 6 of the digital display devices 2 are adapted to update their playlists and loading manifests, from the engine 8.

This update may include the following steps:
c1) The synchronization module 6 of the display device 2 interrogates the engine 8 by sending a request at predetermined intervals, to determine if the engine 8 has a new playlist and/or a new loading manifest corresponding to the digital display device 2. The frequency for interrogating the engine 8 can be fixed (e.g. every few minutes) or determined by a previously downloaded playlist and/or loading manifest from engine 8. For example, the frequency for interrogating the engine 8 for playlists can be fixed (e.g. every few minutes, in particular every 5 minutes) and the frequency for interrogating the engine 8 for loading manifests can be included in the playlists. Playlists and loading manifests can be timestamped, and in order to determine if engine 8 has a new playlist corresponding to the digital display device 2, synchronization module 6 can send a request to engine 8 to receive the timestamp of the current playlist for the digital display device 2. If this timestamp is more recent than the timestamp of the last playlist downloaded by the digital display device 2, then it is determined that engine 8 has a new playlist corresponding to the digital display device 2. The same operation will be applied for the loading manifests.
c2) If it is determined that engine 8 has a new playlist corresponding to the digital display device 2 and/or a new loading manifest, the synchronization module 6 loads the new playlist and/or the new loading manifest from engine 8 (by sending a request asking to receive the new playlist and/or the new loading manifest).
c3) if a new loading manifest has been loaded from the engine 8, the synchronization module 6 of the digital display device 2 determines which is/are the new digital content(s) referenced in the new loading manifest. This determination can be made for example by comparing the digital fingerprints of the digital contents referenced in the new loading manifest with the digital fingerprints of the digital contents already present in the memory of the digital display device 2.
c4) The synchronization module 6 of the digital display device 2 then downloads said new digital content(s) from the URL address(es) corresponding to each digital content indicated in the new loading manifest. In general, this download can take place via the internet 9. The URL addresses in question may correspond to the platform 7 for generating playlists, to another server specific to the operator of the platform 7 for generating playlists or to another location on the Internet.

The player 5 of each digital display device 2 is adapted to play the digital contents corresponding to its current playlist (last playlist loaded by the synchronization module 6) and to display these digital contents on the digital screen 4 of the digital display device 2.

At steps (c1) and (c2), the synchronization module 6 of each digital display device 2 always sends its requests to the same URL address which is specific to the digital display device 2.

At steps (c1) and (c2), the synchronization module 6 and the engine 8 can advantageously communicate in encrypted fashion, for example by using the “https” protocol.

At step (c4), the synchronization module 6 of the digital display device 2 can determine a calculated digital fingerprint of the new downloaded digital content, check whether the calculated digital fingerprint corresponds to the reference digital fingerprint contained in the loading manifest and validate the uploaded digital content only if the calculated digital fingerprint matches the reference digital fingerprint. If the downloaded digital content is not validated, it is destroyed. If the uploading manifest contains two (or more) digital fingerprints for at least some digital contents, this validation may be performed for the different digital fingerprints of the digital content, sequentially or in parallel.

At step (c4), the synchronization module 6 of the digital display device 2 can download the new digital contents in an unencrypted manner, for example by using the “http” protocol.

At step (c4), the synchronization module 6 of the digital display device 2 may, in one embodiment, download the new digital contents piece by piece.

As shown in FIG. 2, at least some of the playlists PL generated by the engine 8 have free time slots FTS, not assigned to a predetermined digital content, while the other time slots are assigned to predetermined contents, for example contents A, B, C, D, E in the example of FIG. 2.

These free time slots FTS are used for programmatic advertising, hence auctioned by means of an automatic bidding process.

To this end, as represented in FIG. 1, the platform 7 for generating playlists may comprise a scheduler module for contents 15 (AD SCH) which communicates with a programmatic platform 20 for selling advertising space (SSP).

The programmatic platform 20 for selling advertising space is a software package which can be executed on one or several servers. It may in particular comprise a content server module 21 (ADSERV), a data exchange module 22 (EXCH) and a content control module 23 (AD CTRL). The data exchange module 22 is adapted to communicate with one or several programmatic platforms 30 for purchasing advertising space (DSP), so as to issue bids concerning the free time slots and to receive in return bid result information. These data exchanges can take place using a standardized data exchange protocol, for example the “OPEN RTB” protocol.

For each free time slot FTS of each playlist PL, corresponding to at least one digital display device 2, the content scheduler module 15 sends a content request to the content server module 21 of the programmatic platform 20 for selling advertising space. The content server module 21 then emits towards the programmatic platform(s) 30 for purchasing advertising space, via the data exchange module 22, an auctioning corresponding to said content request.

The programmatic platform(s) 30 for purchasing advertising space then proceed(s) with the bidding process (“real time bidding”) and, if the bid has been won, send back to said content server module 21, via the data exchange module 22, bid result information corresponding to a digital content having won the bid.

If the bid has been won, the content server module 21 transmits the bid result information to the content scheduler module 15 which then informs of the digital content having won the bid, the digital display device 2 corresponding to the free time slot FTS having been the object of the auctioning. This sending of information to the digital display device 2 can be performed via the aforementioned proxy server 13 and/or any other intermediate proxy server between the digital display device 2 and the platform 7 for generating playlists.

The digital contents present on the programmatic platform(s) 30 for purchasing advertising space can already be known in advance to the programmatic platform 20 for selling advertising space, by data exchange between the programmatic platform(s) 30 for purchasing advertising space and the programmatic platform 20 for selling of advertising space, for example each time a new digital content is referenced on the programmatic platform(s) 30 for purchasing advertising space. The digital contents in question are validated during a moderation process, and the validated digital contents are referenced in the content control module 23 mentioned above. This content control module 23 communicates with the engine 8, which thus references all the digital contents likely to win a bid. The engine 8 thus includes, in the free time slots FTS of each playlist, the references of all the contents likely to win bids, and the references of these contents are also included in the loading manifest of each digital display device 2 at least one playlist of which has a free time slot FTS. Thanks to these loading manifests, the digital display devices 2 are made to load in advance said digital contents likely to win a bid.

Thus, when the engine 8 sends to the digital display device 2 information about the content having won the bid, the content scheduler module 15 sends a very short and very fast message simply containing an order to activate said digital content having won the bid for said free time slot, and this content can almost immediately be displayed by the digital display device 2 since it is already in memory in the digital display device.

The entire process of auctioning and activating the winning digital content can therefore be performed in a very short time, typically a fraction of a second to a few seconds. Typically, the step of sending a content request by the content scheduler device 15 can be performed at the latest between T and 2T before the free time slot, T being the duration of the time slot preceding said free time slot (i.e. usually the duration common to all time slots in the playlist).

It shall be noted that when the bid has not been won following the bidding process described above, the free time slot FTS may be auctioned again in the same way as described above, if there is enough time before the starting moment of said free time slot FTS.

The playlist generation platform 7 can impose free time slots FTS when said playlist generation platform 7 generates playlists according to displaying campaigns controlled independently from the programmatic platform 20 for selling advertising space. For example, the platform 7 for generating playlists can impose a certain percentage of free time slots FTS, which it can distribute for example in an homogeneous manner. In particular, the playlist generation platform 7 can respectively impose percentages of free time slots FTS according to the day and/or according to the time period in the day, and said playlist generation platform 7 can distribute these free time slots, for example, in a homogeneous manner throughout the day or in the time period of the day.

Categories can be assigned to digital content. Said playlist generation platform 7 can assign at least one prohibited category respectively to the free time slots FTS according to the contents already assigned to the adjacent time slots, and when sending a request for content, said platform 7 for generating playlists indicates the prohibited categories to said programmatic platform 20 for selling advertising space.

In this case, each digital display device 2 can be made to load in advance only those of said digital contents likely to win the bid which have a non-prohibited category for the free time slots FTS corresponding to this digital display device 2.

1. A digital display method for outdoor advertising for controlling the display of digital contents by digital display devices, comprising:
generating by a platform for generating playlists, playlists according to displaying campaigns, each playlist comprising information necessary for one or several of said digital display devices to display a set of digital contents during successive time slots, at least some of the playlists having free time slots which are not assigned to a determined digital content;
repeatedly synchronizing the digital display devices with said platform for generating playlists so that each digital display device has in memory the updated playlist generated for it by said platform for generating playlists;
for each free time slot of each playlist, corresponding to at least one digital display device, sending a request for content by said platform for generating playlists, to a programmatic platform for selling advertising space, said programmatic platform for selling advertising space being adapted to emit an auctioning corresponding to said request for content and to send back to said platform for generating playlists, bid result information corresponding to a digital content having won the bid, if the bid has been won;
if the bid has been won, informing of the digital content having won the bid, by said platform for generating playlists, said at least one digital display device corresponding to said free time slot.

2. The method according to claim 1, wherein said programmatic platform for selling advertising space has references of digital contents likely to win the bid in memory and the method further comprises:
having the digital display devices load in advance said digital contents likely to win the bid,
and in order to inform of which content has won the bid, said playlist generation platform indicates to said at least one digital display device corresponding to said free time slot, which digital content has won the bid among said digital contents likely to win the bid.

3. The method according to claim 2, further comprising:
transmitting by said playlist generation platform, to the digital display devices, loading addresses corresponding to the digital contents to be respectively loaded by said digital display devices;
loading said digital contents by the digital display devicesfrom said loading addresses.

4. The method according to claim 3, wherein each playlist includes at least one set of identifiers for digital contents to be played but does not include addresses for loading the digital contents and the method further comprises:
generating by said platform for generating playlists, for each digital display device, a loading manifest comprising at least addresses for loading digital contents;
the synchronization of the digital display devices with said playlist generation platform comprising;
interrogating said playlist generation platform, at predetermined intervals, by each digital display device, in order to determine if said playlist generation platform has a new playlist and/or new loading manifest corresponding to said digital display device;
if so, loading said new playlist and/or said new loading manifest into the digital display device;
if a new loading manifest has been loaded from the server, determining by said digital display device which is/are the new digital content(s) referenced in said loading manifest;
and downloading by said digital display device, said new digital content(s) from the address(es) indicated in the new loading manifest.

5. The method according to claim 4, wherein said programmatic platform for selling advertising space has references of digital contents likely to win the bid in memory and the method further comprises:
having the digital display devices load in advance said digital contents likely to win the bid, and in order to inform of which content has won the bid, said playlist generation platform indicates to said at least one digital display device corresponding to said free time slot, which digital content has won the bid among said digital contents likely to win the bid,
wherein when a playlist includes a free time slot, said playlist includes, for said free time slot, the identifiers of said digital contents likely to win the bid, and the loading manifest corresponding to said playlist includes the addresses for loading said digital contents likely to win the bid,
and in order to inform of the content having won the bid, said platform for generating playlists sends an activation order of said digital content having won the bid for said free time slot.

6. The method according to claim 1, wherein the step of sending a request for content is repeatedly performed for each free time slot, while the bid has not been won.

7. The method according to claim 1, wherein the step of sending a request for content is carried out at the latest between T and 2T before the free time slot, T being the duration of the time slot preceding said free time slot.

8. The method according to claim 1, wherein said playlist generation platform imposes free time slots when said playlist generation platform generates playlists according to displaying campaigns controlled independently of the programmatic platform for selling advertising space.

9. The method according to claim 1, wherein categories are assigned to the digital contents, said playlist generation platform assigns at least one prohibited category respectively to the free time slots according to the contents already assigned to the adjacent time slots, and during said step of sending a request for content, said platform for generating playlists indicates the prohibited categories to said programmatic platform for selling advertising space.

10. The method according to claim 9, wherein said programmatic platform for selling advertising space has references of digital contents likely to win the bid in memory and the method further comprises:
having the digital display devices load in advance said digital contents likely to win the bid, and in order to inform of which content has won the bid, said playlist generation platform indicates to said at least one digital display device corresponding to said free time slot, which digital content has won the bid among said digital contents likely to win the bid,
wherein each digital display device is made to load in advance only those of the said digital contents likely to win the bid which have a category other than the said at least one prohibited category for the free time slots corresponding to this digital display device.

11. A digital display system for outdoor advertising comprising digital display devices and a playlist generation platform, wherein:
said platform for generating playlists is adapted to generate playlists according to displaying campaigns, each playlist comprising information necessary for one or several of said digital display devices to display a set of digital contents during successive time slots, at least some of the playlists having free time slots which are not assigned to a determined digital content;
the digital display system being adapted to repeatedly synchronize the digital display devices with said platform for generating playlists so that each digital display device has in memory the updated playlist generated for it by said platform for generating playlists;
for each free time slot of each playlist, corresponding to at least one digital display device, said playlist generation platform is adapted to send a content request to a programmatic platform for selling advertising space adapted to emit an auctioning corresponding to said content request and to send back to said playlist generation platform, bid result information corresponding to a digital content having won the bid, if the bis has been won;
said platform for generating playlists is adapted to, if the bid has been won, inform of the digital content having won the bid, said at least one digital display device corresponding to said free time slot.

12. The digital display system according to claim 11, further comprising said programmatic platform for selling advertising space,
wherein said programmatic platform for selling advertising space is adapted to send said bid to at least one programmatic platform for buying advertising.

13. The digital display system according to claim 12, wherein:
said programmatic platform for selling advertising space has references of digital contents likely to win the bid in memory;
the digital display system is adapted to have the digital display devices load in advance said digital contents likely to win the bid,
and in order to inform of which content has won the bid, said playlist generation platform is adapted to indicate to said at least one digital display device corresponding to said free time slot, which digital content has won the bid among said digital contents likely to win the bid.

14. The digital display system according to claim 13, wherein:
said playlist generation platform is adapted to transmit to the digital display devices, loading addresses corresponding to the digital contents to be respectively loaded by said digital display devices;
the digital display devices are adapted to load said digital contents from said loading addresses.

15. The digital display system according to claim 14, wherein:
each playlist includes at least one set of identifiers for digital contents to be played but does not include addresses for loading the digital contents;
said platform for generating playlists is adapted to generate, for each digital display device, a loading manifest comprising at least addresses for loading digital contents;
in order to synchronize the digital display devices with said platform for generating playlists, each digital display device is adapted to interrogate said platform for generating playlists at predetermined intervals, to determine if said playlist generation platform has a new playlist and/or a new loading manifest corresponding to said digital display device and if so, to load said new playlist and/or said new loading manifest into the digital display device;
said digital display device is adapted to, if a new loading manifest has been loaded from the server, determine which are the new digital content(s) referenced in said loading manifest and download said new digital content(s) from the address(es) specified in the new loading manifest.

16. The digital display system according to claim 15, wherein:
said programmatic platform for selling advertising space has references of digital contents likely to win the bid in memory;
the digital display system is adapted to have the digital display devices load in advance said digital contents likely to win the bid,
and in order to inform of which content has won the bid, said playlist generation platform is adapted to indicate to said at least one digital display device corresponding to said free time slot, which digital content has won the bid among said digital contents likely to win the bid, wherein when a playlist includes a free time slot, said playlist includes, for said free time slot, the identifiers of said digital contents likely to win the bid, and the loading manifest corresponding to said playlist includes the addresses for loading said digital contents likely to win the bid,
and in order to inform of the content having won the bid, said platform for generating playlists is adapted to send an activation order of said digital content having won the bid for said free time slot.

17. The digital display system according to claim 11, wherein said playlist generation platform is adapted to repeatedly send said request for content for each free time slot, while the bid has not been won.

18. The digital display system according to claim 11, wherein said playlist generation platform is adapted to send said request for content at the latest between T and 2T before the free time slot, T being the duration of the time slot preceding said free time slot.

19. The digital display system according to claim 11, wherein said playlist generation platform is configured to impose free time slots when said playlist generation platform generates playlists based on displaying campaigns controlled independently of the programmatic platform for selling advertising space.

20. The digital display system according to claim 11, wherein categories are assigned to the digital contents, said playlist generation platform is configured to assign at least one prohibited category respectively to the free time slots according to the contents already assigned to the adjacent time slots, said platform for generating playlists indicates the prohibited categories to said programmatic platform for selling advertising space and when sending a request for content.

21. The digital display system according to claim 20, wherein:
said programmatic platform for selling advertising space has references of digital contents likely to win the bid in memory;
the digital display system is adapted to have the digital display devices load in advance said digital contents likely to win the bid,
and in order to inform of which content has won the bid, said playlist generation platform is adapted to indicate to said at least one digital display device corresponding to said free time slot, which digital content has won the bid among said digital contents likely to win the bid, wherein each digital display device is adapted to load in advance only those of the said digital contents likely to win the bid which have a category other than the said at least one prohibited category for the free time slots corresponding to this digital display device.
